(19) United States
(12) Patent Application Publication
(10) Pub. No.: US 2016/0121765 A1
(43) Pub. Date: May 5, 2016

(54) STRUCTURE AND METHOD FOR PROTECTING A PASSENGER DURING A CRASH

(71) Applicants: STANLEY DESJARDINS, SCOTTSDALE, AZ (US); LANCE LABUN, TEMPE, AZ (US); APRIL PINGER, GILBERT, AZ (US)

(72) Inventors: STANLEY DESJARDINS, SCOTTSDALE, AZ (US); LANCE LABUN, TEMPE, AZ (US); APRIL PINGER, GILBERT, AZ (US)

(73) Assignee: SAFE INC., TEMPE, AZ (US)

(21) Appl. No.: 14/530,581

(22) Filed: Oct. 31, 2014

(51) Int. Cl. B60N 2/42

(52) U.S. Cl. CPC B60N 2/42

(57) ABSTRACT

This is a method of absorbing energy that provides a seat system (100) for a vehicle (6) with a first portion (24) and a second portion (26) having a seat (12) for supporting an occupant. A plurality of energy absorbers (28) extends between the first (24) and second (26) portions for absorbing energy on the second portion (26) of the seat system. Any combination of the plurality of energy absorbers (28) provides a discrete energy profile (20). Physical parameters (42) acting on the seat system (100) are detected. The detected physical parameters (42) are used to calculate absorption energy (31). The lowest discrete energy profile (20) is selected that is greater than the calculated absorption energy (31).

### BACKGROUND OF THE INVENTION

The present invention relates, in general, to a method and device for absorbing energy and, more particularly, absorbing crash forces in order to protect a passenger of a vehicle from a substantial load caused by a sudden deceleration of a crash.

The passenger or occupant seated in a vehicle and particularly a helicopter can be subjected to a combination of forces during a crash. If the occupant is appropriately restrained in a seat, the forces generally acting horizontally (i.e., x and y-axes) are typically considered survivable. However, the forces acting substantially vertical (i.e., z-axis) or along the spine of the occupant can produce significant injuries. Injuries to the spine and particularly to the lumbar region can potentially result in paraplegia or death. To mitigate such injuries, energy absorbing seats are generally used, and the portion of the seat supporting the occupant is made to move or travel with the occupant's inertial load during impact. The movement of the seat is referred to as stroking and enables crash energy to be absorbed, thereby reducing the load imposed on the occupant. To reduce the severity of the crash, the energy absorbers are made to absorb as much energy as possible by limiting the stroking such that the seat does not contact the floor of the vehicle.

The stroking of helicopter seats can be achieved by a method that uses a constant load-displacement characteristic called a Fixed Load Energy Absorber (FLEA). The FLEA method attempts to protect the universe of occupants by providing energy absorbers that stroke the seat in response to loads determined by using the mass of a reference occupant, which is typically the 50th percentile of the occupant population. The FLEA works well for an occupant having a weight approaching that of the reference occupant. However, the FLEA performance diminishes as the occupant's weight diverges from the weight of the reference occupant. For example, with energy absorbers designed for the 50^{th} percentile occupant, a lighter occupant is generally exposed to greater deceleration than a heavier occupant, because the occupant's mass is less than the 50^{th} percentile reference occupant. On the other hand, an occupant heavier than the 50^{th} percentile weight can be substantially more at risk of the stroking portion of the seat not fully stroking by contacting the floor. Consequently, the seat with the heavier occupant can normally stroke at a load that is generally less than is tolerable for the occupant's weight, because less crash energy is absorbed than needed to fully decelerate the occupant and stop the seat stroking. In this case, the stroking portion of the seat containing the occupant can suddenly stop. The sudden stop is typically caused by either the non-stroking portion of the seat frame or by or the stroking seat portion contacting the floor beneath the seat. The injury to the occupant can be substantial if the seat fails to stroke within optimal range. To overcome this disadvantage, the Variable Load Energy Absorber (VLEA) was made with the ability for adjusting both the weight and stroking force in order to accommodate the occupant's size. One disadvantage of the VLEA is the reduced capacity to absorb energy. This is because once the load is set a high compressive force to the occupant's spine can occur early during stroking. In order to mitigate this high compressive force, the selected force of the VLEA must be reduced. For this reason, generally less energy can be absorbed over the full stroke of the seat. Another method of energy absorber used on seating systems is called a Fixed Profile Energy Absorber (FPEA). The FPEA method provides a decelerating force on the occupant that varies with seat stroking, which is generally more efficient as compared to either the FLEA or VLEA methods. This efficient stroke is accomplished by maximizing absorbed energy over a specific stroking distance and considers the weight variation of the occupant. Historically, it has been preferred to provide a constant load-displacement energy absorber to absorb the maximum energy for any force and stroke distance. The constant load-displacement creates a loading spike that quickly compresses the occupant's body. A lumbar load spike results immediately followed by a reduction in loading, thereby causing an oscillation as it approaches the constant load applied by the energy absorbers. For the 5^{th} percentile female group having the lowest capacity for withstanding lumbar load, the FLEA is typically modified to keep the spike within the lumbar tolerance of the occupant. Test data shows improved efficiency by gradually increasing the force decelerating the occupant while decreasing the initial load spike. The energy attenuating load can then be increased until the lumbar load approaches its limit. This allows a higher load to be attained over most of the stroking distance, increasing the efficiency of the energy attenuating device. The VLEA, FLEA and FPEA methods provide limited protection for a military seeking greater diversity in personnel. This diversity has resulted in a population that includes an increasing number of female soldiers. For at least this reason, the range of body size or the disparity of the height and weight of the soldier in helicopters has increased. Further, a new generation of crashworthy technology including improved micro-electro-mechanical (MEMS) sensors and semiconductor electronic devices can provide greater speed and accuracy in determining an incipient crash. Employing new technology is necessary to provide optimal safety and survivability to occupants having a wide range of weight and size. The VLEA, FLEA and FPEA methods are lacking for not employing a new generation of crashworthy technology. VLEA, FLEA and FPEA methods do not individually measure the occupant's weight nor do they provide any compensation to the forces needed to safely decelerate occupants of a diverse range of body types over a broad assortment of crash situations.

Hence, there is a need for a method and structure to absorb the energy imposed on any occupant of a crashing aircraft to tolerable magnitudes. And further, there is a need to minimize crash trauma by providing a method for personalizing the seat energy absorbing system. Such a method would account for the occupant's weight and protect the occupant by decelerating using the lowest loads possible and precluding the stroking portion of the seat from contacting the floor of the vehicle.

### SUMMARY OF THE INVENTION

In one general aspect of the invention, a method of absorbing energy provides a seat system for a vehicle and includes a first portion and a second portion having a seat for supporting an occupant, and a plurality of energy absorbers extending between the first and second portions for absorbing energy on the second portion of the seat system such that any combination of the plurality of energy absorbers provides a discrete energy profile. The method further includes detecting physical parameters acting on the seat system, calculating an absorption energy using the detected physical parameters and selects the lowest discrete energy profile that is greater than the calculated absorption energy.

In another general aspect of the invention, a seat system structure of a vehicle is provided and includes a first portion, and a second portion having a seat for supporting an occupant. The invention further includes a plurality of energy absorbers for absorbing energy on the second portion and extends between the first and second portions such that any combination of the plurality of energy absorbers provide a discrete energy profile. Further, the invention includes a port for receiving physical parameters on the seat system and a controller for receiving a signal from the port. The controller on receiving the signal calculates absorption energy and selects the lowest discrete energy profile greater than the calculated absorption energy.

In yet another general aspect of the invention, a method of attenuating energy on a portion of a seat system of a vehicle is provided and includes a first portion and a second portion having a seat for supporting an occupant. A plurality of energy absorbers extend between the first and second portions for absorbing energy on the second portion of the seat system such that any combination of the plurality of energy absorbers provides an discrete energy profile. Further, the method includes sampling physical parameters acting on the seat system and periodically calculating an absorption energy using the detected physical parameters. Finally, the lowest discrete energy profile is selected that is greater than the calculated absorption energy.

### BRIEF DESCRIPTION OF THE DRAWINGS

FIG. 1 is a schematic diagram depicting a seat system for decelerating an occupant;

FIG. 2 is a graph showing the plots of three distinct anthropomorphic test devices;

FIG. 3 is a table illustrating increments of absorption energy of a base energy absorber combined with possible combinations of other energy absorbers;

FIG. 4 is a graph illustrating the possible discrete energy profiles of combining the base energy absorber with combinations of the other energy absorbers;

FIG. 5 is a block diagram illustrating the input and output signals within the seat system and between the seat system and the vehicle; and

FIG. 6 is a flowchart of an algorithm for operating the seat system.

### DETAILED DESCRIPTION OF THE DRAWINGS

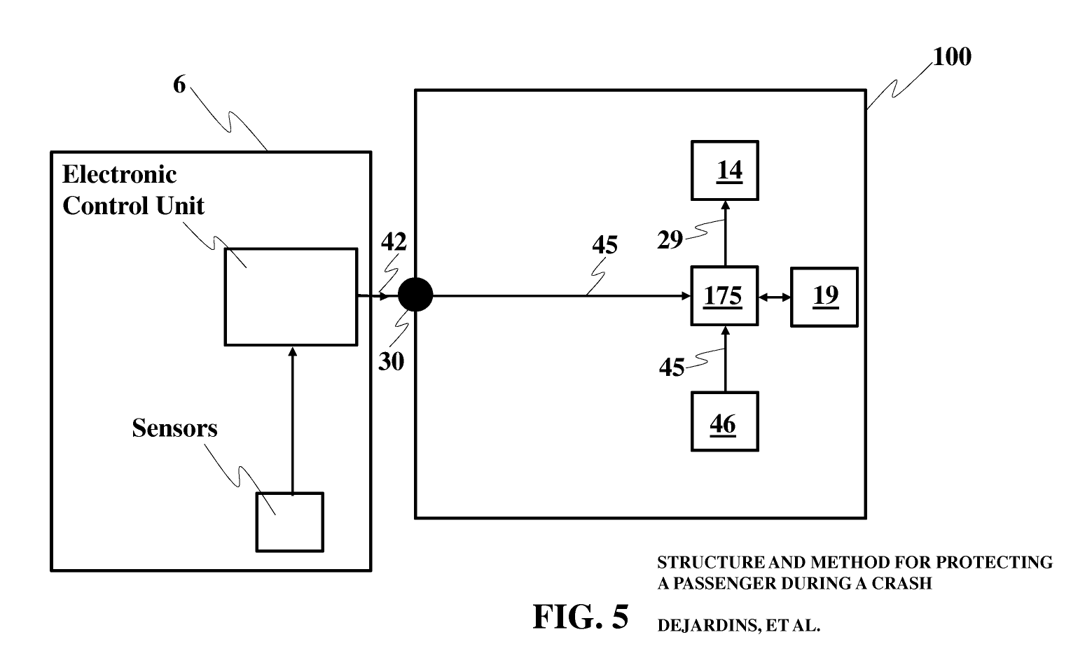

Generally, the invention provides a device and method to configure and/or reconfigure the connection of energy absorbers between two portions of a helicopter seat system for mitigating crash deceleration on an occupant. The two portions of the seat system include a first portion that is attached or coupled to the aircraft and a movable second portion for containing the occupant. On impact, the second portion of the seat system is made to move or stroke generally along a z-axis to reduce the deceleration loading on the occupant. The stroking is controlled by at least one energy absorber of a plurality of energy absorbers for connecting between the first and second portions of the seat system. The plurality of energy absorbers provides the ability to protect a wide range of body types, maximizing efficiency of the system while minimizing trauma to the body. In particular, a portion of each energy absorber provides a distinct force as a function of the stroking distance, referred to as an individual profile, to control the occupant's rate of deceleration. Further, a discrete energy profile comprises any combination of the individual profiles of each energy absorber. In addition to the discrete energy profile, a calculated absorption energy is generated. Real-time signals can be used to convey information or physical parameters at least during an impending crash for determining the needed magnitude of absorption energy in order to minimize deceleration and thus trauma to the occupant. The physical parameters can contain information such as occupant's weight, velocity, attitude of the aircraft, ground conditions, angle in incidence and the like. It is important to note that the direction of the velocity is particularly a vertical component of the velocity. This is because this invention protects the occupant from forces acting substantially vertically as described in the section below for FIG. 5. The physical parameters in the form of signals from sensors located on an aircraft and are received via a port of the seat system having a controller. The controller calculates the required absorption energy to protect the occupant just prior to impact. From all the combinations of discrete energy profiles that can be generated by the energy absorbers, the controller selects the discrete energy profile which absorbs at least the amount of the absorption energy calculated by the controller. This selection can criteria include: First, the selected discrete energy profile must limit the stroking distance so that the seat does not impact the floor of the vehicle. Second, the selected discrete energy profile must provide the lowest absorption energy that is greater than the calculated absorption energy using the measured physical parameters, thus maximizing stroke distance. After the controller selects one of the discrete energy profiles from the various combinations of discrete energy profiles, the controller provides an output signal for selecting the particular combination of energy absorbers to generate the selected discrete energy profile. Finally, the chosen energy absorbers are selected to connect the first and second portions of the seat system. The process of selecting energy absorbers can be an iterative process by the controller reselecting energy absorbers periodically based on changing incipient crash conditions up to some predetermined period prior to the crash. Hence, the invention provides a method and structure for mitigating deceleration on a wide range of diversely sized occupants in a variety of anticipated incipient crash conditions.

The present invention will be better understood from a reading of the following detailed description, taken in conjunction, with the accompanying drawing figures, in which like reference numbers designate like elements and in which:

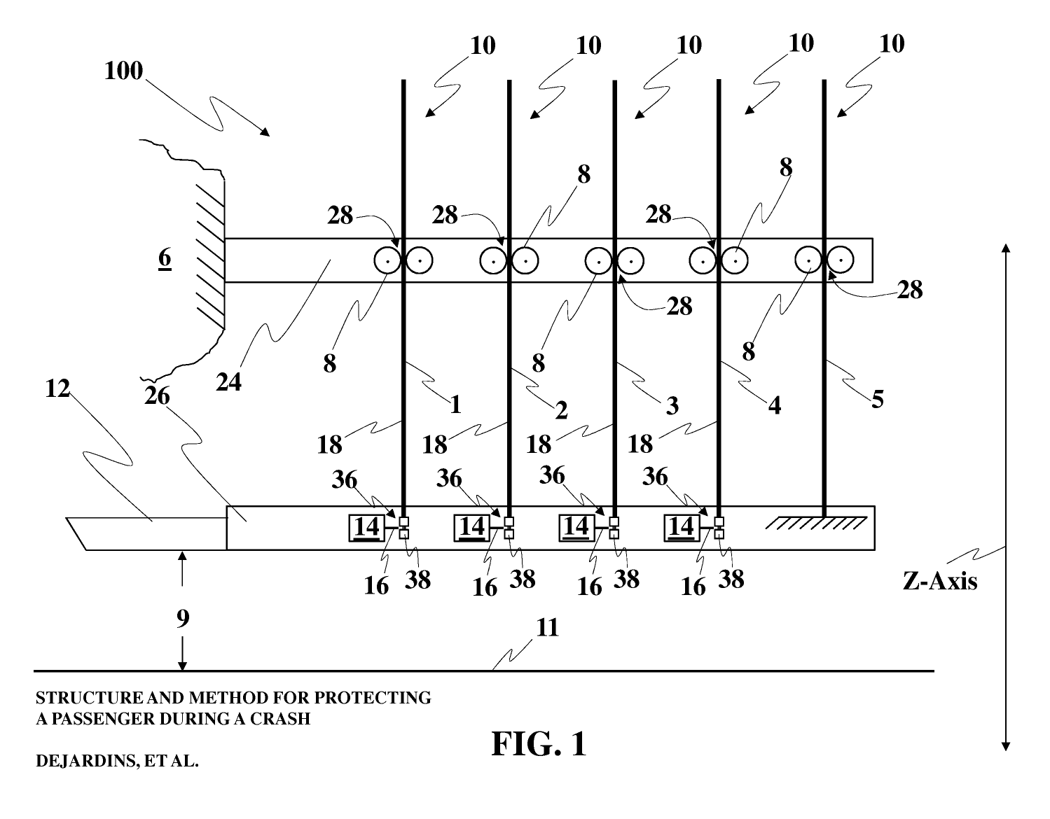

FIG. 1 is a schematic diagram depicting a substantial portion of a seat system 100 including an upper portion 24 connected to a vehicle 6, such as an aircraft, and a movable lower portion 26. The movement of the lower portion 26 is called stroking and generally occurs along a z-axis. The seat system 100 of FIG. 1 protects an occupant during a crash and includes a plurality of energy absorbers 28. In one embodiment, the energy absorber 28 can include a die 8, as depicted in FIG. 1, contacting an energy absorbing member 10 and extend between the upper 24 and lower 26 portions. The energy absorbing members 10 can serve to attenuate loads and can include a range of structures including metal tubes, metal strips and the like. The embodiment of the energy absorber 28 as only a combination of dies 8 and energy absorbing members 10 should not be considered a limitation of the present invention. Counting from left to right in FIG. 1, the energy absorbing members 10 are respectively designated energy absorbing members 1, 2, 3 and 4 and called incremental energy absorbing members 18. As shown in FIG. 1, the lower portion 26 includes a seat 12 for supporting an occupant (not shown) and a plurality of electromechanical devices 14 each having a pin 16, which can be extended into a slotted end-piece 38 disposed on the end of each incremental energy absorbing member 18. The combination of engaging the pin 16 with the slotted end-piece 38 is a structure for connecting the upper 24 and lower 26 portions and is referred to as a latching device 36. The latching device 36, though shown on the lower portion 26, can be disposed on the upper portion 24. The location of the latching devices 36 should not be considered a limitation of the present invention. The latching device 36 provides the ability to select at least one particular incremental energy absorbing member 18 during flight or prior to flight upon occupation of the seat 12, thereby connecting any selected incremental energy absorbing member 18 to the lower portion 26 on electrical activation of any corresponding electromechanical device 14. Flight can be considered any condition where the vehicle 6 is in airspace and not in contact with the ground. The fifth energy absorbing member 10, on the right side as illustrated in FIG. 1, is referred to as a base energy absorbing member 5. The base energy absorbing member 5 is constantly connected between the upper 24 and lower 26 portions and cannot be selected using any electromechanical device 14, unlike the incremental energy absorbing members 18 depicted in FIG. 1.

As illustrated in FIG. 1, the upper portion 24 contains a plurality of energy absorbers 28. In one embodiment to mitigate the severity of the crash on the occupant, any one of the plurality of energy absorbers 28 can be used to provide energy absorption acting in a direction to decelerate the occupant at a reduced rate minimizing crash-induced trauma. The force of the energy absorber 28 typically can be made to vary as a function of the available stroking distance 9. The mitigation of the deceleration commences at impact as the seat 12 starts stroking. A substantial portion of the crash energy or deceleration is absorbed by the energy absorbing member 10. In one embodiment, the energy absorbing member 10 and can be effectively crushed by the dies 8 during stroking. In other words, a substantial portion of the energy can be dissipated by the crushing of the energy absorbing members 10, which are deformed as in one embodiment they move through the dies 8. In FIG. 1, the available stroking distance 9 is depicted between the bottom of the seat 12 and floor surface 11 of the vehicle 6 prior to any stroking. To protect the occupant, it is important that the stroking seat 12 does not impact the floor 11 of the vehicle 6 on completion of the stroking. In another embodiment, the metallurgy and wall thickness of each of the energy absorbing members 10 can be made to absorb particular ranges of energy, thereby allowing a user to compensate for a wide range of body types.

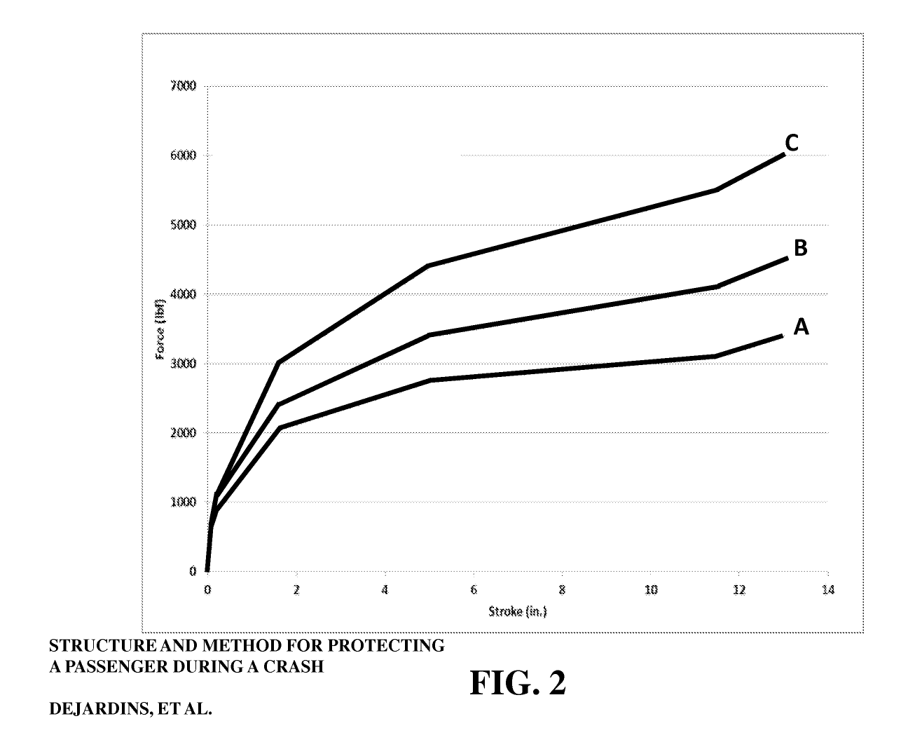

FIG. 2 is a graph depicting three distinct plots A, B and C with the stroking distance in inches along the horizontal axis and the force in pound-force along the vertical axis. The A, B and C plots of FIG. 2 were generated with empirical data gathered using anthropomorphic test devices (ATDs) respectively consisting of (5^{th} percentile female), mid-weight (50^{th} percentile male) and heavy (95^{th} percentile male) occupants. The plots, as shown in FIG. 2, can be referred to as energy absorbing profiles. In particular, the energy absorbing profiles of FIG. 2 were used in the development process to determine the distinct profiles (not shown) of the individual energy absorbing members 10 including the base energy absorbing member 5 and the incremental energy absorbing members 18. It is important to note that the individual profiles for the energy absorbing members 10 were made in order to provide a wide continuous range of energy absorption that includes a generally continuous range of occupant body types and is not limited to the three particular discrete ATDs mentioned above. In one embodiment of the invention, the ability to include a continuous broad range of occupants is accomplished by grouping the base energy absorbing member 5 with up to four incremental energy absorbing members 18. The number of incremental energy absorbing members 18 should not be considered a limitation of the present invention.

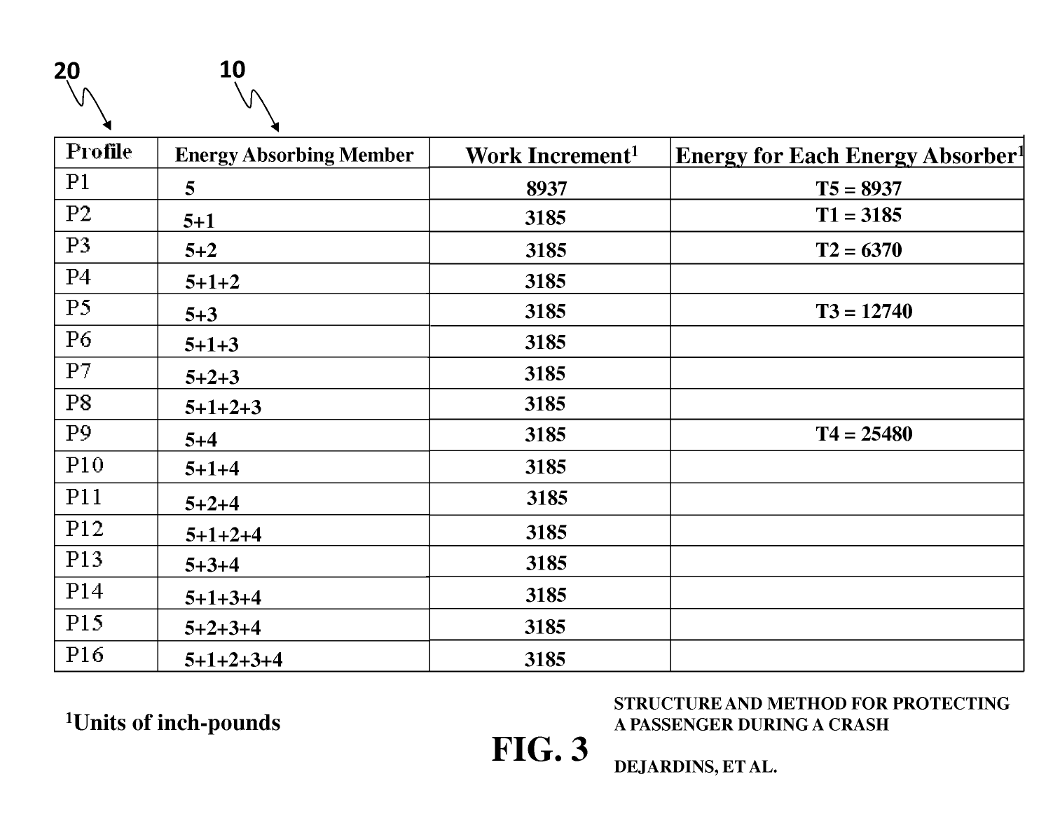

FIG. 3 is a table depicting the various combinations of energy absorbers 28 that make up the respective discrete energy profile 20, which are identified in the first column as P1 through P16. The energy absorbers 28, as discussed above in FIG. 1, can consist of incremental energy absorbing members 18 that include the particular incremental energy absorbing members 1, 2, 3 and 4 and the base energy absorbing member 5. The second column of FIG. 3 shows the particular combinations of the energy absorbers 28 for each discrete energy profile 20. The third column of FIG. 3 called “Work Increment” and depicts the constant incremental energy or work of 3,185 inch-pounds of adding combinations of energy absorbers 28 for each respective discrete energy profile 20. The fourth column of FIG. 3 headed “Energy for Each Energy Absorber” shows the increasing contribution of each incremental energy absorbing member 18. For example, the discrete energy profile P9 includes the base energy absorbing member 5 and energy absorbing member 4. However, energy absorbing member 4 alone contributes 25,480 inch-pounds of energy. This is 8 times 3,185 inch-pounds, which is the incremental work increment. It is important to note that each incremental energy absorbing member 18 contributes distinct amounts of energy based on multiples of the incremental energy 3,185 inch-pounds. The amount of the incremental energy absorption should not be considered a limitation of the present invention. Since each incremental energy absorbing member 18 contributes distinctly increasing amounts of energy, a broad range of energy absorption can be achieved with the combinations of discrete energy profiles 20 in order to cover a diverse population of occupants of varying body types.

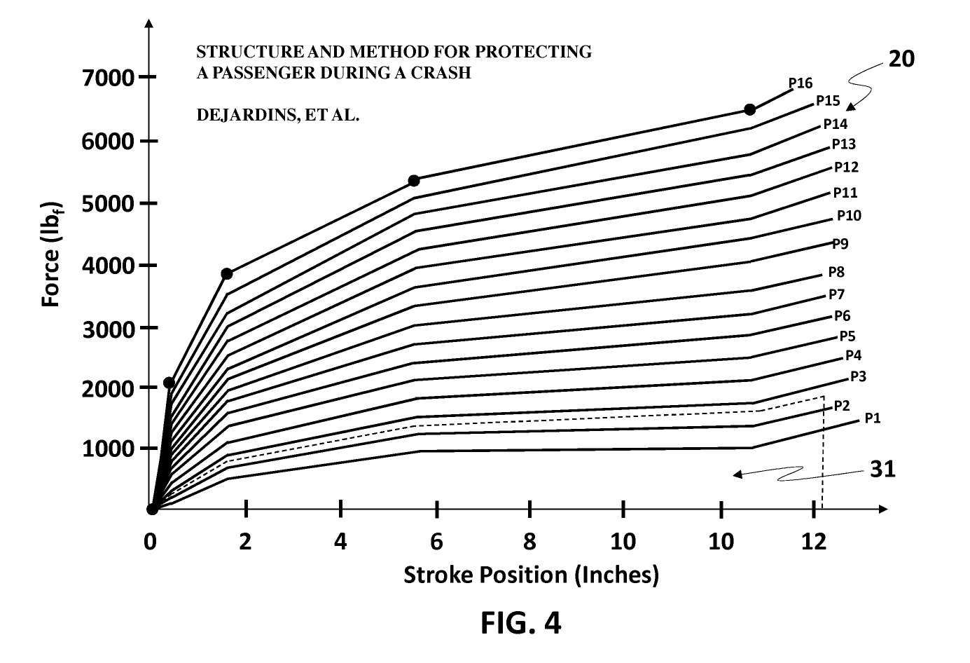

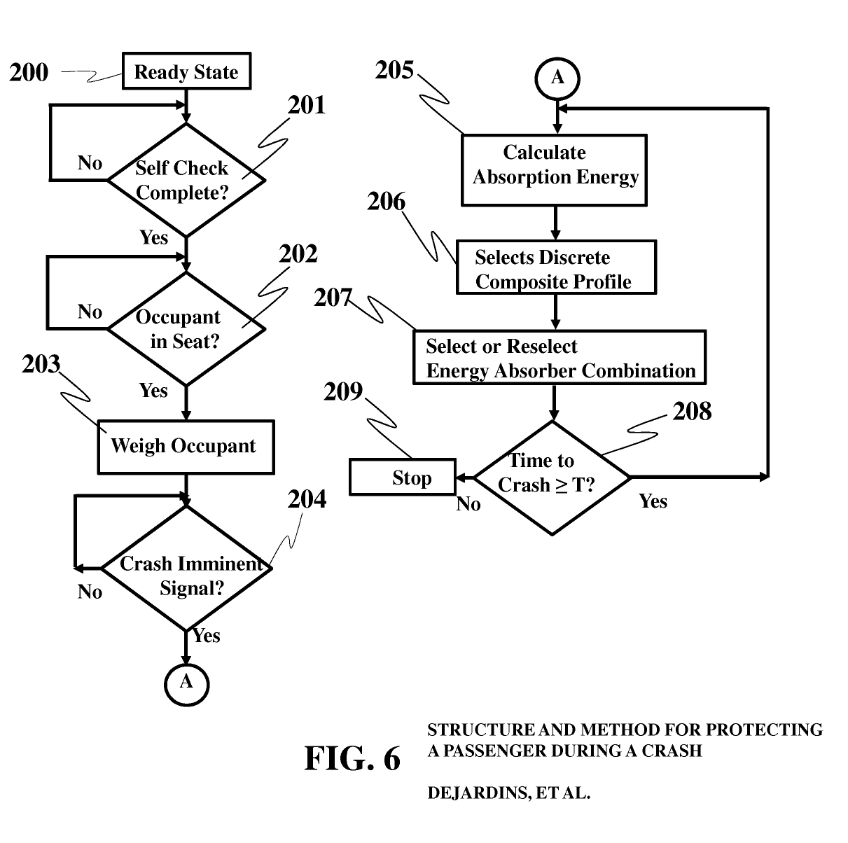

FIG. 4 is a graph depicting 16 discrete energy profiles 20 of energy absorption with the stroking distance in inches along the horizontal axis and the force in pound-force along the vertical axis. Each discrete energy profile 20 is depicted as the result of connecting five inflection points located at particular stroking distances (e.g., 0, 0.5, 2.0, 5.0 and 13.0 inches) with a straight line. The respective force at each inflection point of the discrete energy profile 20 is empirically derived and is associated with obtaining and maintaining lumbar load at a specified level under the maximum tolerable load. The area under each discrete energy profile 20 can represent the energy absorption. As illustrated in FIG. 4, the force used for absorbing the crash energy increases with the portion of distance stroked of the available stroking distance 9 by the seat 12 (see FIG. 1). From the physical parameters 42 (See FIG. 5), the vertical component of the velocity of an incipient crash, among other information, can be used to determine how much force is needed to sufficiently limit the deceleration forces imposed on the occupant. Further, FIG. 4 depicts absorption energy 31, which is calculated using physical parameters 42 as discussed in FIG. 5 and FIG. 6 below. The calculation of absorption energy 31 is based on the known laws of engineering mechanics and can include occupant mass and the received physical parameters 42. In FIG. 4, the absorption energy 31 is represented as an area extending from the horizontal axis to dashed line between profile P2 and P3. As shown in FIG. 4, each grouping of the energy absorbing members 10 provides a discrete energy profile 20 (e.g., P1 through P16). The maximum energy absorption profile consists of using all the energy absorbers 28 added together. The minimum energy absorption is provided by only using the energy absorber 28 having only the base energy absorbing member 5 without the incremental energy absorbing members 18. Further, in one embodiment, incremental amounts of energy absorption can be provided from the maximum to the minimum energy absorption by using any one combination of sixteen possible combinations of the energy absorbers 28. Further yet, the selected combination of energy absorber 28 was designed to decelerate the occupant in a distance less than the available stroking distance 9 (see FIG. 1).

FIG. 5 is a block diagram representing structure of one embodiment for processing information for controlling the seat system 100. In FIG. 5, the vehicle 6 includes an aircraft controller referred to as Electronic Control Unit for receiving signals from aircraft sensors. In FIG. 5, a port 30 on the seat system 100 receives information from the Electronic Control Unit. The port 30 can include electronics devices adapted for receiving either analog or digital information. The information can include at least an imminent crash signal as well as a signal 45 communicating the physical parameters 42 from the aircraft 6. The physical parameters 42 can include the aircraft attitude, altitude and velocity and the like. The velocity as discussed in the invention is substantially the vertical component of velocity along the z-axis as depicted in FIG. 1 or substantially vertically along the major dimension or height of the seat system 100. In another embodiment (not shown), the seat system controller and on-board memory can connect directly to external sensors. From the port 30, the signals 45, as depicted in FIG. 5, are received by a seat system controller 175. A seat sensor 46 communicates the weight of the occupant to the seat system controller 175. The seat system controller 175 performs functions including receiving and processing the signals 45 from the Electronic Control Unit. Further, the seat system controller 175 calculates the required absorption energy 31 based on the signals 45. The seat system controller 175 can access a lookup table within an on-board memory 19 to select an appropriate discrete energy profile 20. The algorithm of the seat system controller 175 selects the closest discrete energy profile 20 having energy absorption greater than or above the calculated absorption energy 31. In addition, the selected discrete energy profile 20 has sufficient energy absorption capacity to preclude the seat 12 from contacting the floor. The electromechanical devices 14 of the seat system 100 receive output signals 29 from the seat system controller 175 for selecting energy absorbing members 10 to establish the appropriate connection between the upper 24 and lower 26 portions to absorb the appropriate amount of energy.

FIG. 6 is a flowchart showing blocks 200 through 209 and describes the steps of the process or algorithm of the software residing in the on-board memory 19 of the seat system controller 175 for the operation of the seat system 100 on the vehicle such as a helicopter. Initially, in block 200 after the occupant vacates the seat 12 (see FIG. 1), a ready state is established by preselecting any particular energy absorbing members 10 as an initial condition customized in the algorithm. In block 201 of FIG. 6, the algorithm residing in the seat system controller 175 performs a self-check of the seat system 100 including continuity testing circuits of the electromechanical devices 14 to assure there are no open or short circuits and initiates polling to test functionality of the seat sensor 46 of the seat 12. In block 203, the occupant is weighed when seated per block 202. In block 204 of FIG. 6, the algorithm looks for the particular imminent crash signal indicating that a velocity over a range of about 15 feet per second to about 55 feet per second, thereby indicating that a crash is imminent. The algorithm steps to block 205 if there is an imminent crash signal. In block 205, the algorithm calculates the absorption energy 31 based on the physical parameters 42 communicated in the signal 45 (FIG. 5). In block 206, the software of the seat system controller 175 selects the discrete energy profile 20. In block 207 of FIG. 6, particular electromechanical devices 14 are activated for selecting the energy absorbing members 10 to generate the selected discrete energy profile 20 by enabling the associated latching device(s) 36 (FIG. 1). If no imminent crash signal is received, the seat system 100 maintains the existing combination of energy absorbing members 10. In block 208, a determination can be made by the algorithm based on how much remaining time is available before an incipient crash. The time needed to select a new combination of energy absorbing members 10 can range from about 50 milliseconds to about 150 milliseconds. If the estimated time to crash is not greater than about 150 milliseconds, the seat system controller 175 does not perform any additional commands and stops. Otherwise, the seat system controller 175 begins to repeat a portion of the process flow path by proceeding to calculate a new absorption energy 31 as depicted in block 205 of FIG. 6. In block 206 a new discrete energy profile 20 can be selected. In block 207 a new combination of energy absorbing members 10 can be selected. This reselection process of new energy absorbing members 10 combinations can occur periodically prior to an incipient crash. For example, a helicopter crashing from a high altitude can continue to accelerate to continuingly higher velocities on approaching a crash, but slow down prior to the crash as a result of pilot input (autorotation), thereby periodically generating new discrete energy profile 20 to accommodate a need for greater energy absorption or less as required. Further, the reselection process can continue periodically as long as the time to crash is a sufficient duration to allow for a reselection of the energy absorbing members 10. The term periodically is a function of the frequency of receiving imminent crash signals and the available time to crash. In addition, if the crash is predicted to have a lower velocity, the seat system controller 175 will select a discrete energy profile 20 to absorb less energy based on a lower calculated absorption energy 31 and thus apply less force to the occupant during the crash. If on the other hand, the calculated absorption energy 31 has a greater energy, then the seat system controller 175 determines a discrete energy profile 20 to absorb more energy, thereby selecting an appropriate combination of energy absorbing members 10 to generate a new discrete energy profile 20. It is important to note that this algorithm is only one possible embodiment for using this invention and should not be considered a limitation of the invention. For example, the algorithm can be written not to include any reselection of energy absorbers.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

We claim:

1. A method of absorbing energy, comprising:
providing a seat system for a vehicle with a first portion and a second portion having a seat for supporting an occupant, and a plurality of energy absorbers extending between the first and second portions for absorbing energy on the second portion of the seat system, wherein any combination of the plurality of energy absorbers provides a discrete energy profile;
detecting physical parameters acting on the seat system;
calculating an absorption energy using the detected physical parameters; and
selecting the lowest discrete energy profile that is greater than the calculated absorption energy.

2. The method of claim 1, further comprising selecting the particular combination of energy absorbers for generating the selected discrete energy profile and connecting the first and second portions.

4. The method of claim 1, wherein detecting the physical parameters comprises weighing the occupant in the seat.

5. The method of claim 1, wherein detecting the physical parameters comprises measuring substantially the vertical velocity of the vehicle.

6. The method of claim 1, wherein the first portion of the seat system is fixed.

7. The method of claim 1, wherein the second portion of the seat system is movable with respect to the first portion.

8. The method of claim 7, wherein selecting the discrete energy profile comprises limiting stroking of the movable second portion to a distance less than the available distance between the seat and a floor surface below the seat system.

9. The method of claim 1, further comprising selecting from the plurality of energy absorbers to a ready state upon the occupant vacating the seat system.

10. A seat system of a vehicle, comprising:
a first portion;
a second portion having a seat for supporting an occupant;
a plurality of energy absorbers for absorbing energy on the second portion and extending between the first and second portions, wherein any combination of the plurality of energy absorbers provides a discrete energy profile;
a port for receiving physical parameters on the seat system and a controller for receiving a signal from the port, and the controller on receiving the signal calculates an absorption energy and selects the lowest discrete energy profile greater than the calculated absorption energy.

11. The device of claim 10, wherein the first portion is connected to the vehicle.

12. The device of claim 10, further comprising a latching device for each energy absorber.

13. The device of claim 12, wherein the controller activates the latching devices of the energy absorbers for the selected lowest discrete energy profile and connects particular energy absorbers between the first and second portions.

14. The device of claim 10, wherein on impact the second portion strokes a distance less than the initial distance under the seat as limited by the selected discrete energy profile.

15. The device of claim 10, further comprising an energy absorber continuously connected between the first and second portions.

16. A method of attenuating energy on a portion of a seat system of a vehicle, comprising:
providing a first portion and a second portion having a seat for supporting an occupant and a plurality of energy absorbers extending between the first and second portions for absorbing energy on the second portion of the seat system, wherein any combination of the plurality of energy absorbers provides a discrete energy profile;
sampling physical parameters acting on the seat system;
periodically calculating an absorption energy using the detected physical parameters; and
periodically selecting the lowest discrete energy profile greater than the calculated absorption energy.

17. The method of claim 16, further comprising periodically reselecting any one particular combination of energy absorbers from the plurality of energy absorbers using the periodically selected lowest discrete energy profile.

18. The method of claim 16, wherein detecting the physical parameters comprises receiving a signal of an imminent crash.

19. The method of claim 16, further comprising stroking of the seat on impact of the seat system.

20. The method of claim 16, wherein periodically calculating the absorption energy comprises estimating a time to crash.
